(19) United States
(12) Patent Application Publication
(10) Pub. No.: US 2002/0152055 A1
(43) Pub. Date: Oct. 17, 2002

(54) Design support system and design support method for multi-chip package

(76) Inventors: Toshiaki Ito, Tokyo (JP); Hirotaka Ito, Hyogo (JP); Hideki Takeuchi, Hyogo (JP); Yoshihiro Ueda, Hyogo (JP); Akiko Yamada, Hyogo (JP); Keiko Mushiake, Hyogo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/986,789

(22) Filed: Nov. 9, 2001

(30) Foreign Application Priority Data
Apr. 16, 2001 (JP) 2001-117270

(51) Int. Cl. G06F 17/50

(52) U.S. Cl. 703/1

(57) ABSTRACT

A design support system includes an information merging section, a connection information generating section and an inter-semiconductor chip and lead frame connection information integrating section. The information merging section captures semiconductor chip information and lead frame information, and generates semiconductor chip and lead frame merged information for each of semiconductor chips. The connection information generating section generates connection information between the semiconductor chips and lead frame from the semiconductor chip and lead frame merged information generated by the information merging section. The inter-semiconductor chip and lead frame connection information integrating section generates integrated connection information between the semiconductor chips and the lead frame, which enables all items of the connection information between the semiconductor chips and lead frame to be displayed on one drawing, from the connection information between the semiconductor chips and lead frame generated by the connection information generating section. The design support system can solve a problem of a conventional design support system in that it is difficult for a user to verify connections between a plurality of semiconductor chips in an MCP (Multi Chip Package).

### BACKGROUND OF THE INVENTION

1. Field of the Invention

The present invention relates to a semiconductor circuit design that specifies interconnection routes between semiconductor chips completing their design and a lead frame, and more particularly to a design support system and a design support method applicable to MCP (Multi-chip package), a technique for packaging a plurality of semiconductor chips into the same package.

2. Description of Related Art

FIG. 30 is a block diagram showing a configuration of a conventional design support system. In FIG. 30, the reference numeral 101 designates a chip design section for carrying out the layout design of semiconductor chips in an interactive manner; 102 designates a lead frame design section for carrying out the design of a lead frame that constitutes external terminals of the semiconductor chips in an interactive manner; 103 designates a data merge section for acquiring chip drawing data and lead frame drawing data from the chip design section 101 and the lead frame design section 102, respectively, to dispose the chip drawing data at ideal positions on the lead frame drawing data; 104 designates a connection diagram generating section for generating a connection diagram that connects the lead frame with pads constituting a connecting section of the semiconductor chips in the merged drawing data produced by the data merge section 103; 105 designates a rule check section for verifying whether the connection diagram between the semiconductor chips and the lead frame produced by the connection diagram generating section 104 satisfies connection rules or not; and 106 designates a complete connection diagram storing section for storing the connection diagram between the semiconductor chips and the lead frame, in which the rule check section 105 does not detect any error.

FIG. 31 is a plan view showing an example of the connection diagram between the first semiconductor chip and the lead frame produced by the conventional design support system. In FIG. 31, the reference numeral 111 designates a lead of the lead frame constituting external terminals of the semiconductor chips; 112 designates a die pad of the lead frame for mounting the semiconductor chips; 113 designates the first semiconductor chip placed on the die pad 112; 114 designate a pad constituting a connecting section of the first semiconductor chip 113; and 115 designates a connecting wire for connecting one of the leads 111 to one of the pads 114.

FIG. 32 is an example of a connection diagram between the second semiconductor chip and the lead frame generated by the conventional design support system. In FIG. 32, the same reference numerals designate the same portions as those of FIG. 31, and the description thereof is omitted here. In FIG. 32, the reference numeral 116 designates the second semiconductor chip mounted on the first semiconductor chip 113 which is placed on the die pad 112, but not shown in FIG. 32; 117 designates a pad constituting a connecting section of the second semiconductor chip 116; and 118 designates a connecting wire for connecting one of the leads 111 with one of the pads 117.

Next, the operation of the conventional design support system will be described.

The design support system carries out the design of the layout and lead frame of the semiconductor chips by the chip design section 101 and lead frame design section 102 in an interactive manner. Subsequently, the data merge section 103 captures chip drawing data designed by the chip design section 101 and lead frame drawing data matching the chip drawing data from the lead frame design section 102, and generates merged drawing data by disposing the chip drawing data at the ideal location on the lead frame drawing data. Subsequently, the connection diagram generating section 104 connects the lead frame with the pads constituting the connecting section of the semiconductor chips automatically or in an interactive manner, thereby generating a connection diagram between the semiconductor chips and the lead frame. Subsequently, the rule check section 105 verifies whether the connection rules that are defined to prevent the wires from being broken or brought into contact are satisfied when the connections are established in the manufacturing process according to the connection diagram between the semiconductor chips and the lead frame. If the rule check section 105 does not detect any error, the complete connection diagram storing section 106 stores the connection diagram between the semiconductor chip and the lead frame. In contrast, when the rule check section 105 detects any error, the connection diagram generating section 104 carries out correction, followed by the verification by the rule check section 105.

To apply the foregoing design support system to the MCP, a technique for reducing the packaging area on a board by encapsulating a plurality of semiconductor chips into the same package, it is necessary to generate the two connection diagrams between the semiconductor chips and the lead frame for the first and second semiconductor chips 113 and 116 as shown in FIGS. 31 and 32. In other words, the connection diagram between the semiconductor chip and the lead frame must be generated for each semiconductor chip.

With the foregoing configuration, the conventional design support system has a problem of making it difficult to verify interconnections between the plurality of semiconductor chips, and hence increasing the number of unverified connections. This is because when the conventional design support system, which produces the diagrams of the connections between the pads constituting the connecting section of the semiconductor chips and the lead frame constituting the external terminals of the semiconductor chip, is applied to the MCP, it generates a diagram showing the connection between the semiconductor chip and the lead frame for each semiconductor chip, thereby verifying each semiconductor chip independently.

Furthermore, since the conventional design support system has its coordinate system reversed for a first surface and a second surface of the lead frame in a mirror-type MCP, it has another problem of making it very difficult to verify the connections between the semiconductor chips.

### SUMMARY OF THE INVENTION

The present invention is implemented to solve the foregoing problems. It is therefore an object of the present invention to provide a design support system and a design support method capable of making it easier to generate and verify diagrams showing connections between a plurality of semiconductor chips and a lead frame in an MCP or a mirror-type MCP.

According to a first aspect of the present invention, there is provided a design support system comprising: an information merging section for capturing semiconductor chip information and lead frame information, and for generating semiconductor chip and lead frame merged information for individual semiconductor chips; a connection information generating section for generating connection information between the semiconductor chips and lead frame for the individual semiconductor chips from the semiconductor chip and lead frame merged information generated by the information merging section; and an inter-semiconductor chip and lead frame connection information integrating section for generating integrated connection information between the semiconductor chips and the lead frame from the connection information between the semiconductor chips and the lead frame generated by the connection information generating section, the integrated connection information enabling the entire connection information between the semiconductor chips and lead frame to be displayed on a single drawing.

Here, the design support system may further comprise a recording section for recording at least one of the semiconductor chip information, lead frame information, the connection information between the semiconductor chips and lead frame and the integrated connection information between the semiconductor chips and the lead frame.

The inter-semiconductor chip and lead frame connection information integrating section may have a display type selection function allowing to select colors and shades of gray when producing a drawing.

The inter-semiconductor chip and lead frame connection information integrating section may have a semiconductor chip selection function allowing to select an arbitrary semiconductor chip when producing a drawing.

The inter-semiconductor chip and lead frame connection information integrating section may have a semiconductor chip group layer selection function allowing to select an arbitrary semiconductor chip group consisting of a plurality of semiconductor chips when producing a drawing.

The inter-semiconductor chip and lead frame connection information integrating section may have a forward/reverse rotation selection function allowing to select forward/reverse rotation of the individual semiconductor chips when producing a drawing.

The inter-semiconductor chip and lead frame connection information integrating section may have a component selection function allowing to select an arbitrary component when producing a drawing.

The inter-semiconductor chip and lead frame connection information integrating section may have a display resealing function allowing to changing a scaling factor of any specified region when producing a drawing.

The inter-semiconductor chip and lead frame connection information integrating section may have a 3-D display function allowing to carry out 3-D display of any specified region when producing a drawing.

The inter-semiconductor chip and lead frame connection information integrating section may have a rotating function allowing to rotate, by any specified angle, the integrated connection information between the semiconductor chips and the lead frame, which is displayed by using at least one of a display resealing function and a 3-D display function.

The inter-semiconductor chip and lead frame connection information integrating section may have a simplified display function allowing to carry out simplified display of the integrated connection information between the semiconductor chips and the lead frame.

The design support system may further comprise a recording section for recording simplified display information, wherein the information merging section may capture the semiconductor chip information, the lead frame information and the simplified display information, and generate semiconductor chip and lead frame merged information for individual semiconductor chips.

The inter-semiconductor chip and lead frame connection information integrating section may have a connection wire number verification function of counting a number of connection wires that are connected to each semiconductor chip.

The design support system may further comprise a print data generating section for generating print data from the integrated connection information between the semiconductor chips and the lead frame; and a drawing data generating section for generating drawing data from the integrated connection information between the semiconductor chips and the lead frame.

According to a second aspect of the present invention, there is provided a design support method comprising: an information merging step of capturing semiconductor chip information and lead frame information, and generating semiconductor chip and lead frame merged information for individual semiconductor chips; a connection information generating step of generating connection information between the semiconductor chips and lead frame for the individual semiconductor chips from the semiconductor chip and lead frame merged information; and an inter-semiconductor chip and lead frame connection information integrating step of generating integrated connection information between the semiconductor chips and the lead frame from the connection information between the semiconductor chips and the lead frame, the integrated connection information making it possible to display the entire connection information between the semiconductor chips and lead frame in a single drawing.

Here, the information merging step may capture the semiconductor chip information, the lead frame information and simplified display information, and generate the semiconductor chip and lead frame merged information for individual semiconductor chips.

The design support method may further comprise a print data generating step of generating print data from the integrated connection information between the semiconductor chips and the lead frame; and a drawing data generating step of generating drawing data from the integrated connection information between the semiconductor chips and the lead frame.

### BRIEF DESCRIPTION OF THE DRAWINGS

FIG. 1 is a block diagram showing a configuration of a design support system of an embodiment 1 in accordance with the present invention;

FIG. 2 is a plan view illustrating integrated connection information between semiconductor chips and a lead frame generated by the design support system of the embodiment 1 in accordance with the present invention;

FIG. 3 is a flowchart illustrating the operation of the design support system of the embodiment 1 in accordance with the present invention;

FIG. 4 is a plan view showing an example of illustrated integrated connection information between semiconductor chips and a lead frame generated by the design support system of an embodiment 2 in accordance with the present invention;

FIG. 5 is a plan view showing another example of the illustrated integrated connection information between the semiconductor chips and the lead frame generated by the design support system of the embodiment 2 in accordance with the present invention;

FIG. 6 is a plan view showing still another example of the illustrated integrated connection information between the semiconductor chips and the lead frame generated by the design support system of the embodiment 2 in accordance with the present invention;

FIG. 7 is a plan view showing an example of illustrated integrated connection information between semiconductor chips and a lead frame generated by the design support system of an embodiment 3 in accordance with the present invention;

FIG. 8 is a plan view showing another example of the illustrated integrated connection information between the semiconductor chips and the lead frame generated by the design support system of the embodiment 3 in accordance with the present invention;

FIG. 9 is a cross-sectional view showing relationships between semiconductor chips and a lead frame in an embodiment 4 in accordance with the present invention;

FIG. 10 is a plan view showing an example of illustrated integrated connection information between the semiconductor chips and the lead frame generated by the design support system of the embodiment 4 in accordance with the present invention;

FIG. 11 is a cross-sectional view showing relationships between semiconductor chips and a lead frame in an embodiment 5 in accordance with the present invention;

FIG. 12 is a plan view showing an example of illustrated integrated connection information between a first semiconductor chip and the lead frame generated by the design support system of the embodiment 5 in accordance with the present invention;

FIG. 13 is a plan view showing an example of illustrated integrated connection information between a second semiconductor chip and the lead frame generated by the design support system of the embodiment 5 in accordance with the present invention;

FIG. 14 is a plan view showing another example of illustrated integrated connection information between the semiconductor chips and the lead frame generated by the design support system of the embodiment 5 in accordance with the present invention;

FIG. 15 is a plan view showing an example of illustrated integrated connection information between a semiconductor chip and a lead frame generated by the design support system of an embodiment 6 in accordance with the present invention;

FIG. 16 is a plan view and an enlarged view of its part showing illustrated integrated connection information between semiconductor chips and a lead frame to explain a display rescaling function in an embodiment 7 in accordance with the present invention;

FIG. 17 is a plan view and an enlarged perspective view of its part showing illustrated integrated connection information between semiconductor chips and a lead frame to explain a 3-D display function in an embodiment 8 in accordance with the present invention;

FIG. 18 is enlarged perspective views showing parts of illustrated integrated connection information between semiconductor chips and a lead frame to explain a rotating function in an embodiment 9 in accordance with the present invention;

FIG. 19 is a plan view showing an example of illustrated integrated connection information between semiconductor chips and a lead frame generated by the design support system of an embodiment 10 in accordance with the present invention;

FIG. 20 is a simplified display diagram showing an example of a simplified display generated by the design support system of the embodiment 10 in accordance with the present invention;

FIG. 21 is a simplified display diagram showing another example of a simplified display generated by the design support system of the embodiment 10 in accordance with the present invention;

FIG. 22 is a simplified display diagram showing an example of a simplified display generated by the design support system of an embodiment 11 in accordance with the present invention;

FIG. 23 is a plan view showing an example of illustrated integrated connection information between semiconductor chips and a lead frame generated by the design support system of the embodiment 11 in accordance with the present invention;

FIG. 24 is a block diagram showing a configuration of a design support system of an embodiment 12 in accordance with the present invention;

FIG. 25 is a simplified display diagram showing an example of a simplified display generated by the design support system of the embodiment 12 in accordance with the present invention;

FIG. 26 is a flowchart illustrating the operation of the design support system of the embodiment 12 in accordance with the present invention;

FIG. 27 is a verification table showing a resultant example obtained by counting the number of connections generated by the design support system of an embodiment 13 in accordance with the present invention;

FIG. 28 is a block diagram showing a configuration of a design support system of an embodiment 14 in accordance with the present invention;

FIG. 29 is a flowchart illustrating the operation of the design support system of the embodiment 14 in accordance with the present invention;

FIG. 30 is a block diagram showing a configuration of a conventional design support system;

FIG. 31 is a plan view showing connections between a first chip and a lead frame generated by the conventional design support system; and

FIG. 32 is a plan view showing connections between a second chip and the lead frame generated by the conventional design support system.

### DETAILED DESCRIPTION OF THE PREFERRED EMBODIMENTS

The invention will now be described with reference to the accompanying drawings.

### Embodiment 1

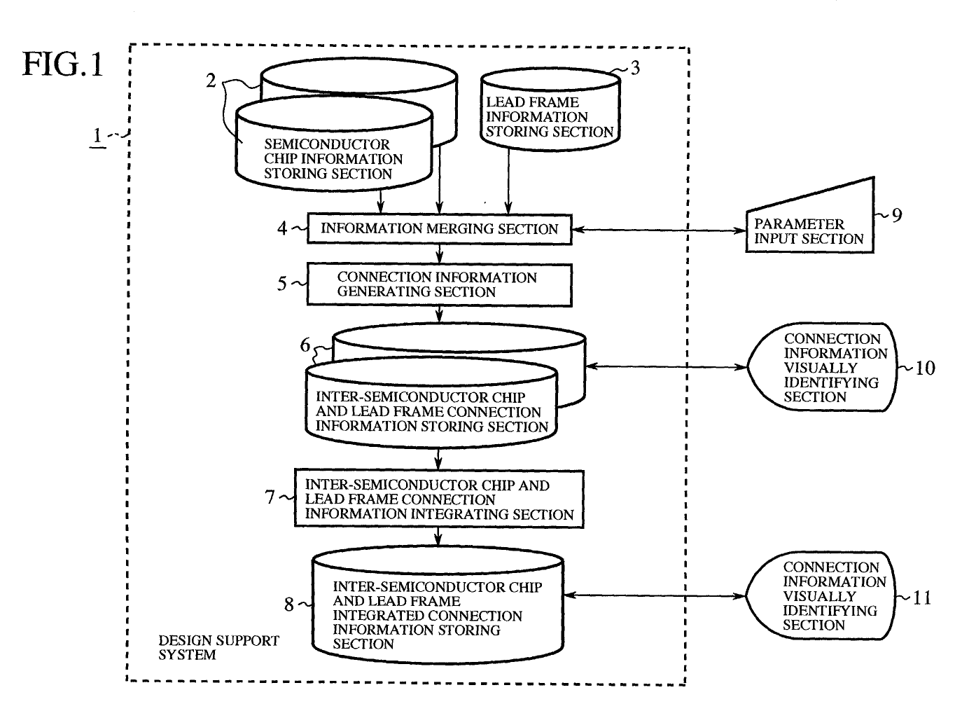

FIG. 1 is a block diagram showing a configuration of a design support system of an embodiment 1 in accordance with the present invention. In FIG. 1, the reference numeral 1 designates a design support system for generating a connection diagram between a plurality of semiconductor chips and a lead frame. In the design support system 1, the reference numeral 2 designates a semiconductor chip information storing section for storing pad information that is stored in a magnetic recording device to indicate the number and location of the pads of the semiconductor chips, and chip outline information that indicates the sizes of the semiconductor chips and the like; 3 designates a lead frame information storing section for storing lead information that indicates the number and location of the leads of the lead frame recorded in the magnetic recording device, and die pad information that indicates the size of the die pad and the like; 4 designates an information merging section for reading the semiconductor chip information and the lead frame information from the semiconductor chip information storing section 2 and the lead frame information storing section 3, respectively, and for generating semiconductor chip and lead frame merged information by combining the relative coordinate systems of the semiconductor chips and the lead frame for the individual semiconductor chips to represent them in a single drawing; 5 designates a connection information generating section for generating connection information between the semiconductor chips and the lead frame by connecting the pads of the semiconductor chips and the lead frame for individual semiconductor chips in the semiconductor chip and lead frame merged information created by the information merging section 4; 6 designates an inter-semiconductor chip and lead frame connection information storing section for storing the connection information between the semiconductor chips and the lead frame created by the connection information generating section 5; 7 designates an inter-semiconductor chip and lead frame connection information integrating section for generating the connection information between all the semiconductor chips and the lead frame by integrating, according to the coordinates of the lead frame, the connection information between the semiconductor chips and lead frame created for the individual semiconductor chips; and 8 designates an inter-semiconductor chip and lead frame integrated connection information storing section for storing the integrated connection information between the semiconductor chips and the lead frame created by the inter-semiconductor chip and lead frame connection information integrating section 7.

In FIG. 1, the reference numeral 9 designates a parameter input section for inputting or changing parameters about the coordinates and size of the semiconductor chips or the lead frame; 10 designates a connection information visually identifying section for producing a drawing from the connection information between the semiconductor chips and the lead frame stored in the inter-semiconductor chip and lead frame connection information storing section 6, thereby enabling a user to verify the connections by watching them on a monitor; and 11 designates a connection information visually identifying section for producing a drawing from the integrated connection information between the semiconductor chips and the lead frame stored in the inter-semiconductor chip and lead frame integrated connection information storing section 8, thereby enabling a user to verify the connections by watching them on the monitor.

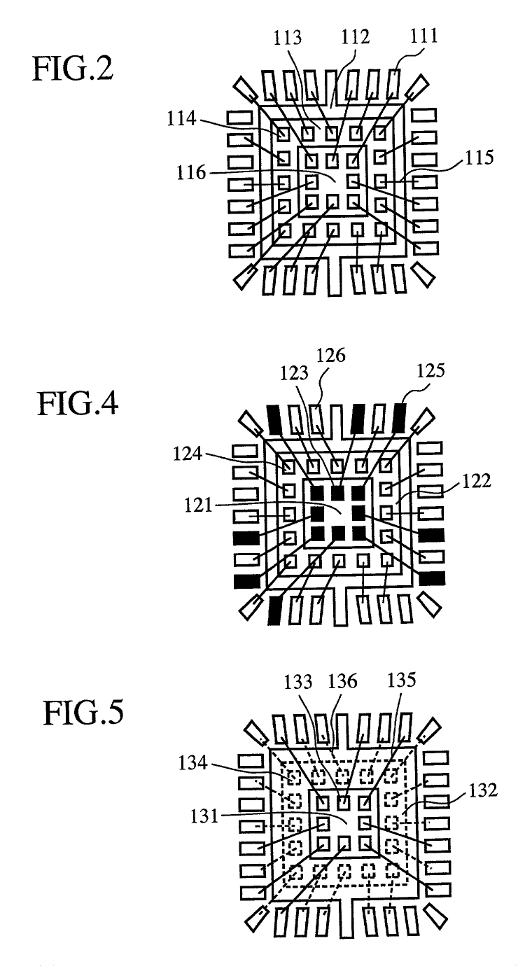

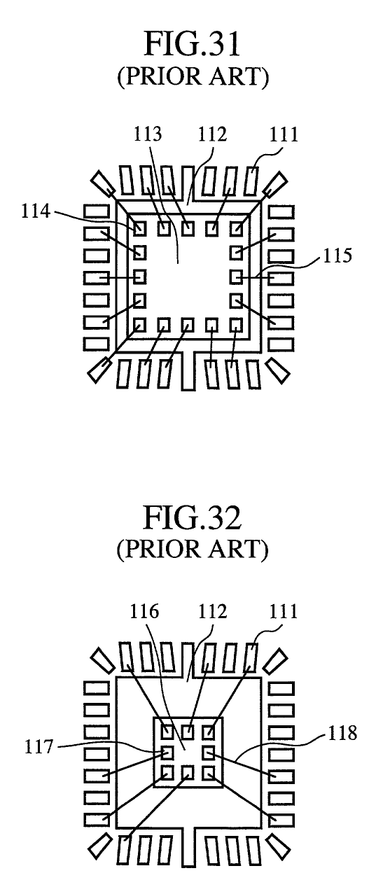

FIG. 2 is a plan view showing illustrated integrated connection information between the semiconductor chips and the lead frame generated by the design support system of the embodiment 1 in accordance with the present invention. In FIG. 2, the same reference numerals designate the same or like portions to those of FIGS. 31 and 32 showing the conventional technique, and the description thereof is omitted here.

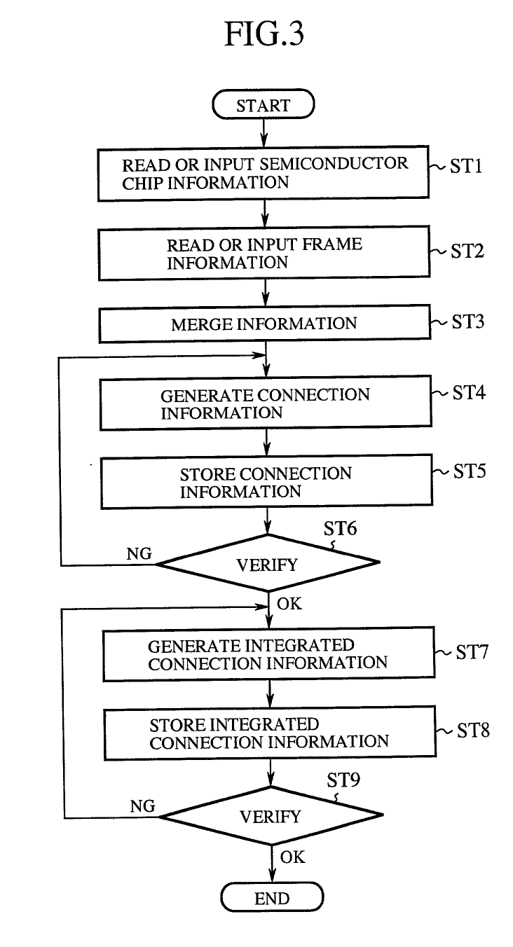

Next, the operation of the present embodiment 1 will be described with reference to a flowchart of FIG. 3 illustrating the operation of the design support system of the embodiment 1 in accordance with the present invention.

First, at step ST1, the information merging section 4 reads the semiconductor chip information including the pad information and chip outline information from the semiconductor chip information storing section 2 or captures it from the parameter input section 9. Subsequently, at step ST2, the information merging section 4 reads the lead frame information including the lead information and die pad information from the lead frame information storing section 3 or captures it from the parameter input section 9. Subsequently, at step ST3, the information merging section 4 creates the semiconductor chip and lead frame merged information from the semiconductor chip information and the lead frame information by combining the relative coordinate systems of the semiconductor chips and the lead frame for the individual semiconductor chips so that the semiconductor chip and lead frame merged information can be represented by a single drawing.

Subsequently, at step ST4, as with the semiconductor chip and lead frame merged information created for the individual semiconductor chips, the connection information generating section 5 connects the lead frame with the pads of the semiconductor chips, thereby generating the connection information between the semiconductor chips and the lead frame. Subsequently, at step ST5, the inter-semiconductor chip and lead frame connection information storing section 6 stores the connection information between the semiconductor chips and the lead frame created for the individual semiconductor chips. Subsequently, at step ST6, the user verifies the connection information between the semiconductor chips and the lead frame on the connection information visually identifying section 10, and the processing proceeds to step ST7 when there is no error in the verified result, and to step ST4 if there is any problem.

Subsequently, at step ST7, the inter-semiconductor chip and lead frame connection information integrating section 7 produces the entire connection information between the semiconductor chips and the lead frame by integrating the connection information between the semiconductor chips and the lead frame created for the individual semiconductor chips according to the coordinates of the lead frame. Subsequently, at step ST8, the inter-semiconductor chip and lead frame integrated connection information storing section 8 stores the integrated connection information between the semiconductor chips and the lead frame. Subsequently, at step ST9, the user verifies the integrated connection information between semiconductor chips and the lead frame on the connection information visually identifying section 11, and the processing is completed when no problem occurs in the verified result, but is returned to step ST7 if any problem happens in the verified result.

After that, at step ST9, the connection information visually identifying section 11 displays a view as illustrated in FIG. 2 using the integrated connection information between semiconductor chips and the lead frame, thereby enabling the user to verify the first semiconductor chip 113 and the second semiconductor chip 116 simultaneously.

As described above, the present embodiment 1 is configured such that the inter-semiconductor chip and lead frame connection information integrating section 7 produces the integrated connection information between semiconductor chips and the lead frame from the connection information between the semiconductor chips and the lead frame created for the individual semiconductor chips. As a result, the present embodiment 1 offers an advantage of being able to facilitate generating the diagram illustrating the connections between the plurality of semiconductor chips and the lead frame in the MCP or mirror-type MCP, thereby enabling the user to verify the connections easily.

Although the structure is explained which has the two semiconductor chips 113 and 116 stacked on the die pad 112 in the present embodiment 1, the structure is not essential. For example, a structure having a given number of semiconductor chips that have any positional relationships with the lead frame can offer similar advantages.

### Embodiment 2

Since the design support system of the present embodiment 2 in accordance with the present invention has the same basic configuration as the design support system of the foregoing embodiment 1 as shown in FIG. 1, the description thereof is omitted here. However, the design support system of the present embodiment 2 differs from that of FIG. 1 in that it comprises an inter-semiconductor chip and lead frame connection information integrating section, which differs from its counterpart 7 in FIG. 1 in that it has a display type selection function allowing to select colors and shades of gray when producing a drawing.

FIGS. 4-6 show examples of the illustrated integrated connection information between the semiconductor chips and the lead frame, which is generated by the design support system of the present embodiment 2 in accordance with the present invention. In FIG. 4, the reference numeral 121 designates a first semiconductor chip; 122 designates a second semiconductor chip; 123 designates a pad of the first semiconductor chip 121, which is represented by a closed square; 124 designates a pad of the second semiconductor chip 122, which is represented by an open square; 125 designates a lead which is connected to one of the pads 123 of the first semiconductor chip 121 by a connecting wire, and is represented by a closed rectangle; and 126 designates a lead which is connected to one of the pads 124 of the second semiconductor chip 122 by a connecting wire, and is represented by an open rectangle.

In FIG. 5, the reference numeral 131 designates a first semiconductor chip; 132 designates a second semiconductor chip represented thinly; 133 designates a pad of the first semiconductor chip 131; 134 designates a pad of the second semiconductor chip 132, which is represented thinly; 135 designates a connecting wire that connects one of the pads of the first semiconductor chip 131 with one of the leads; and 136 designates a connecting wire that connects one of the pads of the second semiconductor chip 132 with one of the leads, and is represented thinly.

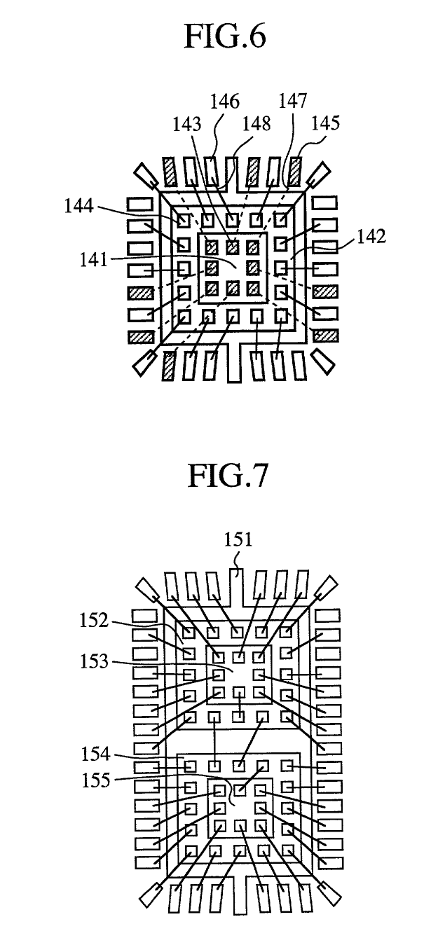

In FIG. 6, the reference numeral 141 designates a first semiconductor chip; 142 designates a second semiconductor chip; 143 designates a pad of the first semiconductor chip 141, which is represented in a particular pattern; 144 designates a pad of the second semiconductor chip 142; 145 designates a lead that is connected to one of the pads 143 of the first semiconductor chip 141 via a connecting wire, and is represented in the particular pattern; 146 designates a lead connected to one of the pads 144 of the second semiconductor chip 142 via a connecting wire; 147 designates a connecting wire that connects one of the pads 143 of the first semiconductor chip 141 with one of the leads 145, and is represented by a broken line; and 148 designates a connecting wire that connects one of the pads 144 of the second semiconductor chip 142 with one of the leads 146, and is represented by a solid line.

Next, the operation of the present embodiment 2 will be described.

Since the basic operation of the design support system of the present embodiment 2 is the same as that of the foregoing embodiment 1 as shown in FIG. 3, the description thereof is omitted here. However, the design support system of the embodiment 2 makes it easier for a user to verify the connections between the semiconductor chips and the lead frame by selecting colors, shades of gray or the like when creating a drawing from the integrated connection information between semiconductor chips and the lead frame as shown in FIGS. 4-6 by the connection information visually identifying section 11 at step ST9.

As described above, the present embodiment 2 is configured such that the inter-semiconductor chip and lead frame connection information integrating section 7 has the display type selection function allowing to select the colors and shades of gray when producing a drawing, and generates the integrated connection information between the semiconductor chips and the lead frame from the connection information between the semiconductor chips and the lead frame, which is produced for the individual semiconductor chips. Thus, the present embodiment 2 can select the color, shades of grays or the like when making the drawing. As a result, it offers an advantage of being able to easily generate and verify the drawing that represents the connections between the plurality of semiconductor chips and the lead frame.

Incidentally, the colors or patterns explained in the present embodiment 2 are only examples, which do not limit the scope of the present invention, and it is obvious that any other colors and patterns can offer similar advantages.

### Embodiment 3

Since the design support system of the present embodiment 3 in accordance with the present invention has the same basic configuration as that of the foregoing embodiment 1 as shown in FIG. 1, the description thereof is omitted here. However, the design support system of the present embodiment 3 differs from that of FIG. 1 in that it comprises an inter-semiconductor chip and lead frame connection information integrating section, which differs from its counterpart 7 in FIG. 1 in that it has a semiconductor chip selection function allowing to select any of the semiconductor chips when producing a drawing.

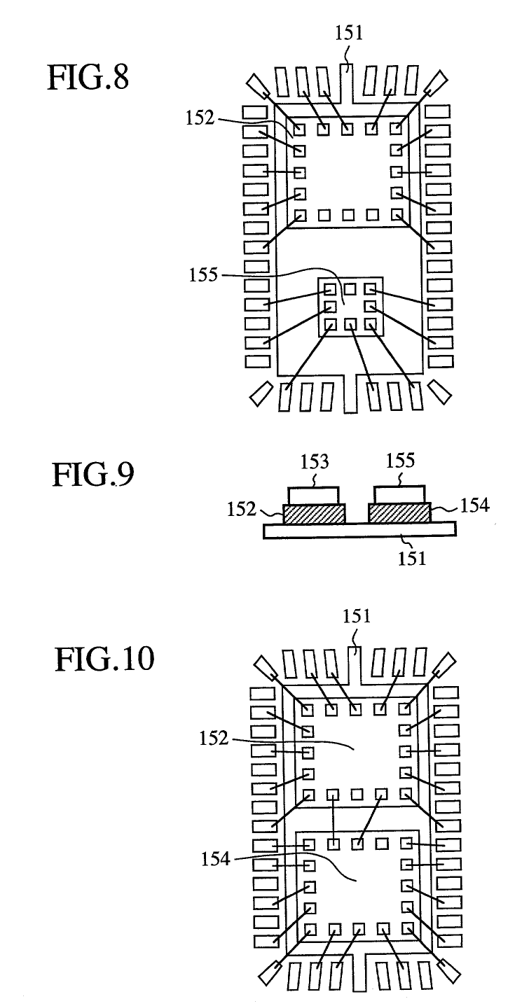

FIGS. 7-8 show examples of the illustrated integrated connection information between the semiconductor chips and the lead frame, which is generated by the design support system of the present embodiment 3 in accordance with the present invention. In these figures, the reference numeral 151 designates a die pad of a lead frame; 152 designates a first semiconductor chip; 153 designates a second semiconductor chip disposed on the first semiconductor chip 152; 154 designates a third semiconductor chip; and 155 designates a fourth semiconductor chip disposed on the third semiconductor chip 154. FIG. 8 shows a case where the first semiconductor chip 152 and fourth semiconductor chip 155 are selected to be illustrated.

Next, the operation of the present embodiment 3 will be described.

Since the basic operation of the design support system of the present embodiment 3 in accordance with the present invention is the same as that of the foregoing embodiment 1 as shown in FIG. 3, the description thereof is omitted here. However, the design support system of the embodiment 3 makes it easier for a user to verify the connections between the selected semiconductor chip(s) and the lead frame by selecting the semiconductor chip(s) when creating a drawing from the integrated connection information between the semiconductor chips and the lead frame as shown in FIGS. 7 and 8 by the connection information visually identifying section 11 at step ST9.

As described above, the present embodiment 3 is configured such that the inter-semiconductor chip and lead frame connection information integrating section 7 has the semiconductor chip selection function allowing to select any semiconductor chip(s) when making a drawing, and generates the integrated connection information between the semiconductor chips and the lead frame from the connection information between the semiconductor chips and lead frame, which is produced for the individual semiconductor chips. Thus, the present embodiment 3 can select any semiconductor chips when producing the drawing. As a result, it offers an advantage of being able to easily generate a drawing that represents the connections between the selected semiconductor chips and the lead frame, thereby enabling the user to verify the connections with ease.

Incidentally, the number of the semiconductor chips and their positional relationships explained in the present embodiment 3 are only examples, and do not limit the scope of the present invention. It is obvious that any number and positional relationships of the semiconductor chips can offer similar advantages.

### Embodiment 4

Since the design support system of the embodiment 4 in accordance with the present invention has the same basic configuration as that of the foregoing embodiment 1 as shown in FIG. 1, the description thereof is omitted here. However, the design support system of the present embodiment 4 differs from that of FIG. 1 in that it comprises an inter-semiconductor chip and lead frame connection information integrating section, which differs from its counterpart 7 in FIG. 1 in that it has a semiconductor chip group layer selection function allowing to select a semiconductor chip group on a desired layer in an MCP when producing a drawing.

FIG. 9 is a cross-sectional view showing positional relationships between semiconductor chips and a lead frame in the present embodiment 4 in accordance with the present invention, which corresponds to a cross-sectional view of the illustrated integrated connection information between the semiconductor chips and he lead frame as shown in FIG. 7. In FIG. 9, the same reference numerals designate the same or like portions to those of FIG. 7, and the description thereof is omitted here.

FIG. 10 is a plan view showing an example of the illustrated integrated connection information between the semiconductor chips and the lead frame generated by the design support system of the present embodiment 4. In FIG. 10, the same reference numerals designate the same or like portions to those of FIG. 7, and the description thereof is omitted here.

Next, the operation of the present embodiment 4 will be described.

Since the basic operation of the design support system of the present embodiment 4 is the same as that of the foregoing embodiment 1 as shown in FIG. 3, the description thereof is omitted here. However, the design support system of the embodiment 4 makes it easier for a user to verify the connections between the semiconductor chip groups on a selected layer and the lead frame by selecting the semiconductor chip group on any desired layer in the MCP when creating a drawing from the integrated connection information between the semiconductor chips and the lead frame as shown in FIG. 10 by the connection information visually identifying section 11 at step ST9.

As described above, the present embodiment 4 is configured such that the inter-semiconductor chip and lead frame connection information integrating section 7 has the semiconductor chip group layer selection function allowing to select the semiconductor chip group of any desired layer in the MCP when producing a drawing, and generates the integrated connection information between the semiconductor chips and lead frame from the connection information between the semiconductor chips and lead frame, which is produced for the individual semiconductor chips. Thus, the present embodiment 4 can select the semiconductor chip group of the selected layer in the MCP when producing a drawing. As a result, it offers an advantage of being able to easily generate the drawing which represents the connections between the semiconductor chip group on the selected layer and the lead frame, thereby enabling the user to verify the connections with ease.

Incidentally, although the number of the selected layers in the MCP is only one in the present embodiment 4, this is not essential. A multiple number of layers can be selected instead.

### Embodiment 5

Since the design support system of the embodiment 5 in accordance with the present invention has the same basic configuration as that of the foregoing embodiment 1 as shown in FIG. 1, the description thereof is omitted here. However, the design support system of the embodiment 5 differs from that of FIG. 1 in that it comprises an inter-semiconductor chip and lead frame connection information integrating section which differs from its counterpart 7 in FIG. 7 in that it has a forward/reverse rotation selection function of selecting the forward/reverse rotation of the individual semiconductor chips in a mirror-type MCP when producing a drawing.

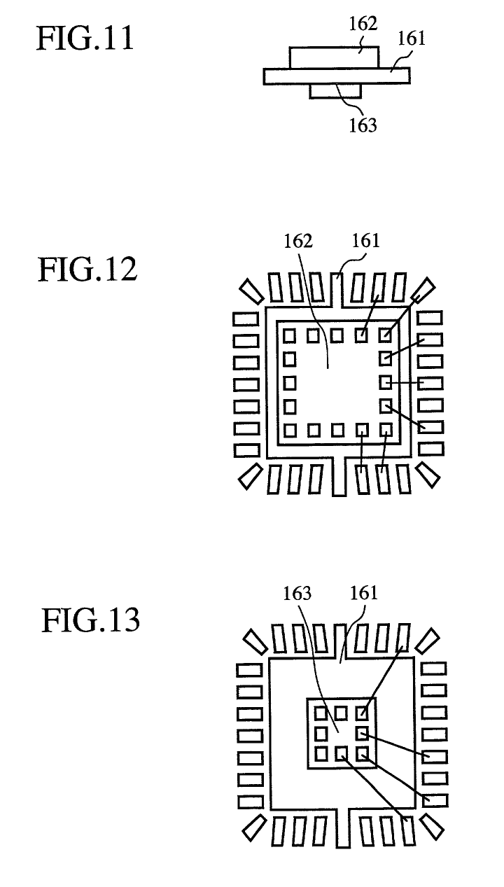

FIG. 11 is a cross-sectional view showing positional relationships between the semiconductor chips and the lead frame in the present embodiment 5. FIGS. 12-14 are plan views each showing an example of illustrated integrated connection information between the semiconductor chips and the lead frame generated by the design support system of the embodiment 5. In these figures, the reference numeral 161 designates a die pad of a lead frame; 162 designates a first semiconductor chip; and 163 designates a second semiconductor chip. As shown in FIG. 11, the mirror-type MCP comprises the semiconductor chips on its first and second surfaces of the die pad 161.

Next, the operation of the present embodiment 5 will be described.

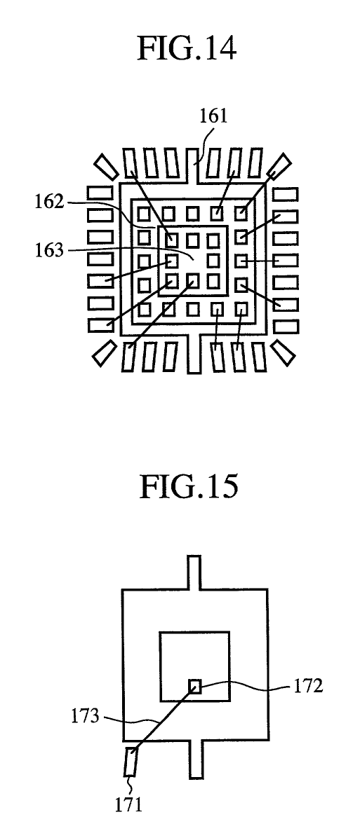

Since the basic operation of the design support system of the present embodiment 5 is the same as that of the foregoing embodiment 1 as shown in FIG. 3, the description thereof is omitted here. However, the design support system of the present embodiment 5 makes it easier for a user to verify the connections of the second semiconductor chip 163 mounted on the second surface of the die pad 161 by selecting the forward/reverse rotation of each semiconductor chip in the mirror-type MCP when producing a drawing as shown in FIGS. 12 and 13 from the integrated connection information between the semiconductor chips and the lead frame by the connection information visually identifying section 11 at step ST9. In addition, generating a transparent view as shown in FIG. 14 enables the user to verify the forwardly rotated semiconductor chip and the reversely rotated semiconductor chip simultaneously in the mirror-type MCP when producing a drawing by the connection information visually identifying section 11.

As described above, the present embodiment 5 is configured such that the inter-semiconductor chip and lead frame connection information integrating section 7 has a forward/reverse rotation selection function allowing to select the forward/reverse rotation of each semiconductor chip in the mirror-type MCP when making the drawing, and generates the integrated connection information between the semiconductor chips and the lead frame from the connection information between the semiconductor chips and the lead frame which is generated for the individual semiconductor chips. Thus, the present embodiment 5 can select the forward/reverse rotation of each semiconductor chip in the mirror-type MCP when producing a drawing, and create the transparent view that enables the user to verify the forwardly and reversely rotated semiconductor chips simultaneously. As a result, it offers an advantage of being able to easily generate the drawing that represents the connections between the individual semiconductor chips and the lead frame in the mirror-type MCP, thereby enabling a user to verify the connections.

### Embodiment 6

Since the design support system of the embodiment 6 in accordance with the present invention has the same basic configuration as that of the foregoing embodiment 1 as shown in FIG. 1, the description thereof is omitted here. However, the design support system of the present embodiment 6 differs from that of FIG. 1 in that it comprises an inter-semiconductor chip and lead frame connection information integrating section which differs from its counterpart 7 in FIG. 1 in that it has a component selection function of selecting any of the components such as any leads of the lead frame, any pads of the semiconductor chips, or any connecting wires.

FIG. 15 shows illustrated integrated connection information between one of the semiconductor chips and the lead frame generated by the design support system of the present embodiment 6. In FIG. 15, the reference numeral 171 designates a lead of a selected lead frame; 172 designates a pad connected to the lead 171 via a connecting wire 173; and 173 designates the connecting wire that connects the lead 171 and the pad 172.

Next, the operation of the present embodiment 6 will be described.

Since the basic operation of the design support system of the embodiment 6 is the same as that of the foregoing embodiment 1 as shown in FIG. 3, the description thereof is omitted here. However, the design support system of the present embodiment 6 operates differently in that the connection information visually identifying section 11 produces a drawing as shown in FIG. 15 from the integrated connection information between the semiconductor chips and the lead frame at step ST9, and displays only the lead 171, pad 172 and connecting wire 173 interconnecting them by selecting the lead 171 of the lead frame when producing the drawing with eliminating the remaining leads, pads and connecting wires. Thus, the present embodiment 6 can make it easier for the user to verify the connection between any specified components.

As described above, the present embodiment 6 is configured such that the inter-semiconductor chip and lead frame connection information integrating section 7 has a component selection function of selecting any desired lead of the lead frame, any pad of the semiconductor chip(s) or any connecting wire when producing a drawing, and generates the integrated connection information between the semiconductor chips and lead frame from the connection information between the semiconductor chips and lead frame produced for the individual semiconductor chips. Thus, because of the function of the present embodiment 6 of selecting any desired components when producing the drawing, it offers an advantage that the user can verify the connection between the selected components more easily.

Although the present embodiment 6 is described taking an example of selecting only one for each component, it can select a plurality of components.

### Embodiment 7

Since the design support system of the embodiment 7 in accordance with the present invention has the same basic configuration as that of the foregoing embodiment 1 as shown in FIG. 1, the description thereof is omitted here. However, the design support system of the present embodiment 7 differs from that of FIG. 1 in that it comprises an inter-semiconductor chip and lead frame connection information integrating section that differs from its counterpart 7 of FIG. 1 in that it has a display resealing function allowing to change the scaling factor of the display of any region.

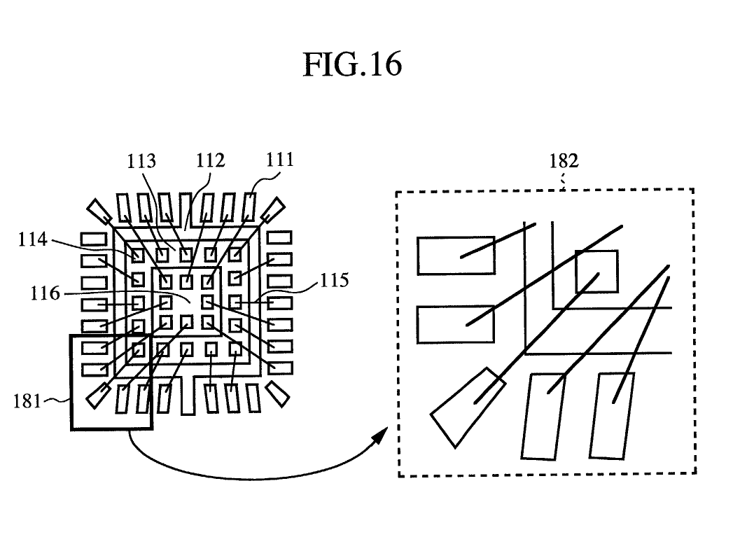

FIG. 16 is a plan view showing illustrated integrated connection information between the semiconductor chips and the lead frame and its enlarged view to explain the display resealing function in the design support system of the embodiment 7 in accordance with the present invention. In FIG. 16, since the same reference numerals designate the same or like portions to those of FIG. 2, the description thereof is omitted here. In FIG. 16, the reference numeral 181 designates a rectangle for specifying any desired region of the illustrated integrated connection information between the semiconductor chips and the lead frame as shown in FIG. 2; and 182 designates a rescaled rectangle obtained by expanding or contracting the region specified by the rectangle 181.

Next, the operation of the present embodiment 7 will be described.

Since the basic operation of the design support system of the present embodiment 7 is the same as that of the foregoing embodiment 1 as shown in FIG. 3, the description thereof is omitted here. However, the connection information visually identifying section 11 of the present embodiment 7 can produce a drawing as shown in FIG. 16 from the integrated connection information between the semiconductor chips and the lead frame at step ST9, and change the scaling factor of any desired region of the illustrated integrated connection information between the semiconductor chips and the lead frame by specifying the region by the rectangle 181. As a result, the present embodiment 7 enables the user to verify the connections with ease and at high efficiency.

As described above, the present embodiment 7 is configured such that the inter-semiconductor chip and lead frame connection information integrating section 7 has a display resealing function capable of changing the scaling factor of any desired region, and generates the integrated connection information between the semiconductor chips and the lead frame from the connection information between the semiconductor chips and lead frame produced for individual semiconductor chips. Thus, the present embodiment 7 can specify any desired region of the illustrated integrated connection information between the semiconductor chips and the lead frame by the rectangle 181, and change the scaling factor thereof. As a result, it offers an advantage of enabling the user to easily verify the connections at high efficiency.

Although the desired region is specified by the rectangle 181 in the present embodiment 7, this is not essential. It can be specified by other schemes.

### Embodiment 8

Since the design support system of the embodiment 8 in accordance with the present invention has the same basic configuration as that of the foregoing embodiment 1 as shown in FIG. 1, the description thereof is omitted here. However, the design support system of the present embodiment 8 differs from that of FIG. 1 in that it comprises an inter-semiconductor chip and lead frame connection information integrating section which differs from its counterpart 7 in FIG. 1 in that it has a 3-D display function of enabling a 3-D display of any 3-D region.

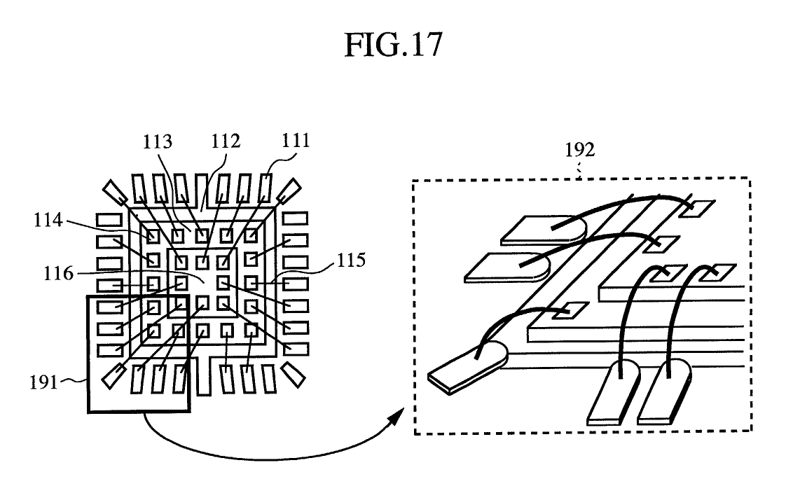

FIG. 17 is a plan view and an enlarged perspective view of its part showing illustrated integrated connection information between the semiconductor chips and the lead frame for explaining the 3-D display function in the design support system of the embodiment 8 in accordance with the present invention. In FIG. 17, the same reference numerals designate the same or like portions to those of FIG. 2, and the description thereof is omitted here. In FIG. 17, the reference numeral 191 designates a rectangle for specifying any desired region in the illustrated integrated connection information between the semiconductor chips and the lead frame as shown in FIG. 2; and 192 designates a 3-D display rectangular section for carrying out 3-D display of the region specified by the rectangle 191.

Next, the operation of the present embodiment 8 will be described.

Since the basic operation of the design support system of the embodiment 8 is the same as that of the foregoing embodiment 1 as shown in FIG. 3, the description thereof is omitted here. However, the connection information visually identifying section 11 of the present embodiment 8 can produce a drawing as shown in FIG. 17 from the integrated connection information between the semiconductor chips and the lead frame at step ST9, and carry out the 3-D display by specifying any desired region of the illustrated integrated connection information between semiconductor chips and the lead frame by the rectangle 191. As a result, the present embodiment 8 can enable the user to verify the connections at high efficiency with ease.

As described above, the present embodiment 8 is configured such that the inter-semiconductor chip and lead frame connection information integrating section 7 has the 3-D display function capable of carrying out the 3-D display of any desired region, and generates the integrated connection information between the semiconductor chips and the lead frame from the connection information between the semiconductor chips and the lead frame produced for individual semiconductor chips. Thus, the present embodiment 8 can specify any desired region of the illustrated integrated connection information between the semiconductor chips and the lead frame by the rectangle 191, and carry out the 3-D display thereof. As a result, it offers an advantage that enables the user to verify the connections at high efficiency with ease.

Although the desired region is specified by the rectangle 191 in the present embodiment 8, this is not essential. It can be specified by other schemes.

### Embodiment 9

Since the design support system of the embodiment 9 in accordance with the present invention has the same basic configuration as that of the foregoing embodiment 1 as shown in FIG. 1, the description thereof is omitted here. However, the design support system of the present embodiment 9 differs from that of FIG. 1 in that it comprises an inter-semiconductor chip and lead frame connection information integrating section that differs from its counterpart 7 in FIG. 1 in the following functions: first, the 3-D display function of enabling the 3-D display of any 3-D region; second, the display rescaling function of enabling changing the scaling factor of any region; and third, the rotation function enabling rotating, by any desired angle, the illustrated integrated connection information between the semiconductor chips and the lead frame, which has been subject to the 3-D display function or display resealing function.

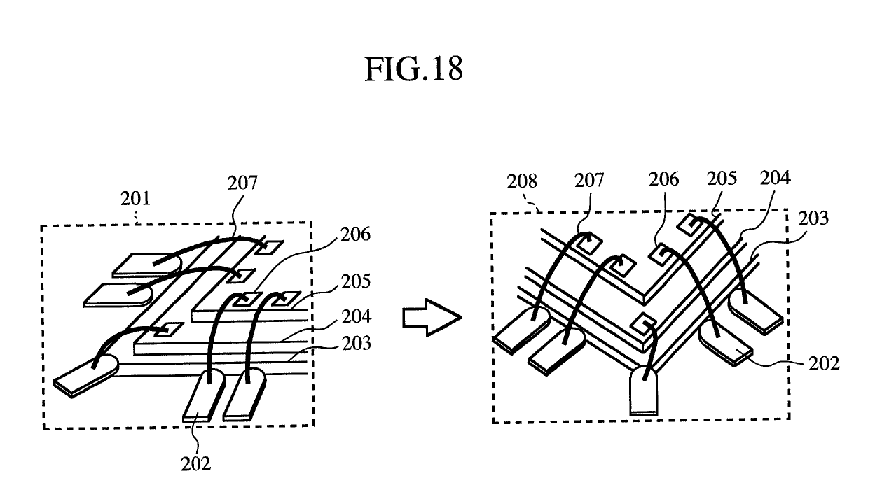

FIG. 18 is perspective views showing illustrated integrated connection information between the semiconductor chips and the lead frame for explaining the rotating function in the embodiment 9 in accordance with the present invention. In FIG. 18, the reference numeral 201 designates a 3-D display rectangular section for displaying the integrated connection information between the semiconductor chips and the lead frame in a 3-D display fashion by the 3-D display function; 202 designates a lead of a lead frame; 203 designates a die pad of the lead frame; 204 designates a first semiconductor chip; 205 designates a second semiconductor chip; 206 designates a pad of the second semiconductor chip 205; 207 designates a connecting wire for connecting one of the leads 202 with one of the pads 206; and 208 designates a 3-D display rectangular section obtained by turning the point of view by 45 degrees counterclockwise with respect to the integrated connection information between semiconductor chips and the lead frame that is 3-D displayed by the rotating function.

Next, the operation of the present embodiment 9 will be described.

Since the basic operation of the design support system of the present embodiment 9 is the same as that of the foregoing embodiment 1 as shown in FIG. 3, the description thereof is omitted here. However, the design support system of the present embodiment 9 operates differently at step ST9 in that the connection information visually identifying section 11 produces the drawings as shown in FIG. 18 from the integrated connection information between the semiconductor chips and the lead frame, and that when the illustrated integrated connection information between the semiconductor chips and the lead frame is 3-D displayed or rescaled, the connection information visually identifying section 11 rotates it in any direction and reillustrates it. Thus, the present embodiment 9 enables the user to verify the connections with ease at high efficiency.

As described above, the present embodiment 9 is configured such that the inter-semiconductor chip and lead frame connection information integrating section 7 has the 3-D display function allowing the 3-D display of any desired region, the display resealing function allowing to change the scaling factor of any desired region, and the rotating function allowing the rotation by an arbitrary angle of the illustrated integrated connection information between the semiconductor chips and the lead frame, which is displayed by the 3-D display function or the display rescaling function, and generates the integrated connection information between the semiconductor chips and the lead frame from the connection information between the semiconductor chips and lead frame produced for the individual semiconductor chips. Thus, the present embodiment 9 makes it possible for the integrated connection information between the semiconductor chips and the lead frame that undergoes the 3-D display or scaling display to be rotated in any direction or to be reillustrated. As a result, the present embodiment 9 offers an advantage of enabling a user to verify the connections with ease at high efficiency.

### Embodiment 10

Since the design support system of the embodiment 10 in accordance with the present invention has the same basic configuration as that of the foregoing embodiment 1 as shown in FIG. 1, the description thereof is omitted here. However, the design support system of present embodiment 10 differs from that of FIG. 1 in that its inter-semiconductor chip and lead frame connection information integrating section differs from its counterpart 7 in FIG. 1 in that it has a simplified display function of displaying the integrated connection information between the semiconductor chips and the lead frame in a simplified manner.

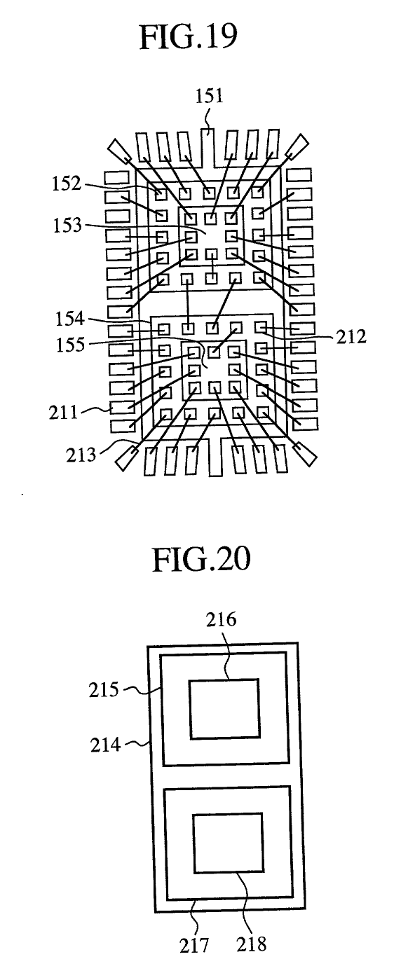

FIG. 19 is a plan view showing an example of illustrated integrated connection information between the semiconductor chips and the lead frame that is generated by the design support system of the embodiment 10 in accordance with the present invention. In FIG. 19, the same reference numerals designate the same or like portions to those of FIG. 7, and the description thereof is omitted here. In FIG. 19, the reference numeral 211 designates a lead of the lead frame; 212 designates a pad of each semiconductor chip; and 213 designates a connecting wire for connecting one of the leads 211 and one of the pads 212.

FIG. 20 is a simplified display diagram showing a simplified display produced by the design support system of the embodiment 10. It corresponds to a simplified display of the illustrated integrated connection information between the semiconductor chips and the lead frame shown in FIG. 19. In FIG. 20, the reference numeral 214 designates a die pad passing through the simplified display; 215 designates a first semiconductor chip passing through the simplified display; 216 designates a second semiconductor chip passing through the simplified display; 217 designates a third semiconductor chip passing through simplified display; and 218 designates a fourth semiconductor chip passing through the simplified display. The semiconductor chips 215-218 passing through the simplified display are a schematic representation of the chip outline information included in the semiconductor chip information.

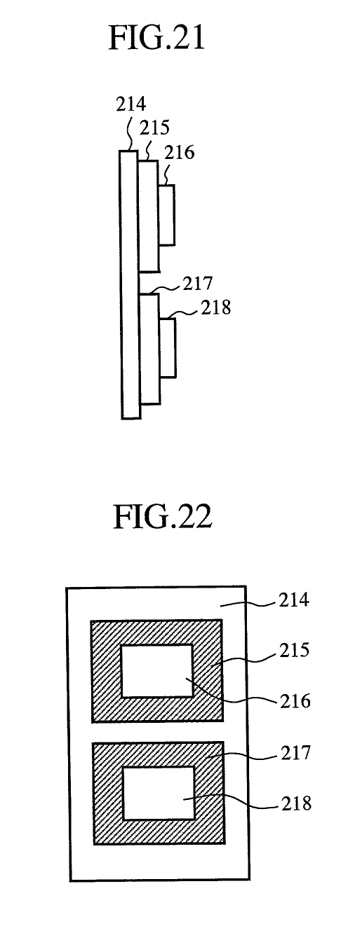

FIG. 21 is a simplified display diagram showing another simplified display generated by the design support system of the embodiment 10. It corresponds to a simplified display obtained by rotating the illustrated integrated connection information between the semiconductor chips and the lead frame as shown in FIG. 20 by 90 degrees. In FIG. 21, the same reference numerals designate the same or like portions to those of FIG. 20, and the description thereof is omitted here.

Next, the operation of the present embodiment 10 will be described.

Since the basic operation of the design support system of the embodiment 10 is the same as that of the foregoing embodiment 1 as shown in FIG. 3, the description thereof is omitted here. However, the operation of the design support system in the present embodiment 10 differs at step ST9 in that the connection information visually identifying section 11 graphically represents the integrated connection information between the semiconductor chips and the lead frame as shown in FIGS. 19-21, and that when making the simplified display of the illustrated integrated connection information between the semiconductor chips and the lead frame, it can omit the many individual leads 211, pads 212 and connecting wires 213, thereby enabling high-speed drawing. As a result, the connection verification becomes easier and more efficient.

As described above, the present embodiment 10 is configured such that the inter-semiconductor chip and lead frame connection information integrating section 7 has the simplified display function of enabling the simplified display of the integrated connection information between the semiconductor chips and the lead frame, and generates the integrated connection information between the semiconductor chips and the lead frame from the individual items of the connection information between the semiconductor chips and the lead frame produced for the respective semiconductor chips. As a result, the present embodiment 10 can achieve the high-speed drawing of the integrated connection information between the semiconductor chips and the lead frame in a simplified display form, thereby offering an advantage of enabling the high efficiency and quick verification of the connections.

### Embodiment 11

Since the design support system of the embodiment 11 in accordance with the present invention has the same basic configuration as that of the foregoing embodiment 1 as shown in FIG. 1, the description thereof is omitted here. However, the design support system of present embodiment 11 differs from that of FIG. 1 in that its inter-semiconductor chip and lead frame connection information integrating section differs from its counterpart 7 in FIG. 1 in that it has a simplified display function of displaying the integrated connection information between the semiconductor chips and the lead frame in a simplified manner.

FIG. 22 is a simplified display diagram showing a simplified display produced by the design support system of the embodiment 11. In FIG. 22, the same reference numerals designate the same or like portions to those of FIG. 20, and the description thereof is omitted here. In FIGS. 22, shaded portions indicate the first semiconductor chip 215 and the third semiconductor chip 217, which undergo the simplified display.

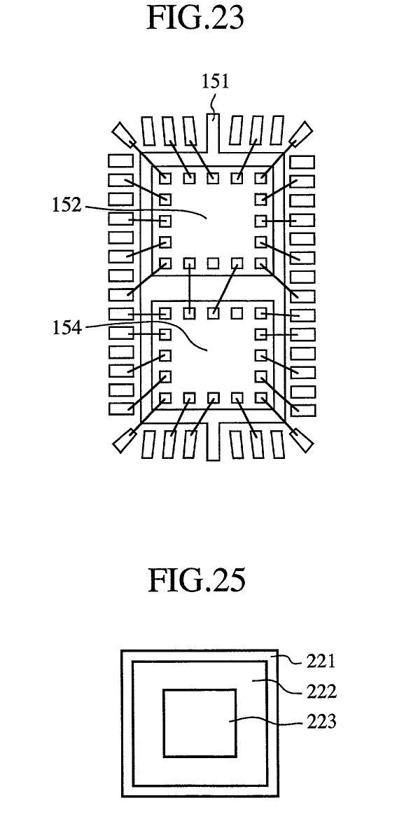

FIG. 23 is a plan view showing an example of illustrated integrated connection information between the semiconductor chips and the lead frame that is generated by the design support system of the present embodiment 11. In FIG. 23, the same reference numerals designate the same or like portions to those of FIG. 7, and the description thereof is omitted here.

Next, the operation of the present embodiment 11 will be described.

Since the basic operation of the design support system of the embodiment 11 is the same as that of the foregoing embodiment 1 as shown in FIG. 3, the description thereof is omitted here. However, the operation of the design support system in the present embodiment 11 differs at step ST9 in that the connection information visually identifying section 11 graphically represents the integrated connection information between the semiconductor chips and the lead frame as shown in FIGS. 22 and 23, and that when making the simplified display of the illustrated integrated connection information between the semiconductor chips and the lead frame, it enables the user to verify the connections between a selected semiconductor chip and the frame easily and quickly by selecting any desired one from the semiconductor chips passing through the simplified display.

As described above, the present embodiment 11 is configured such that the inter-semiconductor chip and lead frame connection information integrating section 7 has the simplified display function of enabling the simplified display of the integrated connection information between the semiconductor chips and the lead frame, and generates the integrated connection information between the semiconductor chips and the lead frame from the individual items of the connection information between the semiconductor chips and the lead frame produced for the respective semiconductor chips. As a result, the present embodiment 11 can select any desired one from the integrated connection information between the semiconductor chips and the lead frame in a simplified display form, thereby offering an advantage of enabling the user to easily verify the connections at high efficiency.

Although the present embodiment 11 represents the selected semiconductor chips by the shaded portions, other display patterns, colors or the like can be used.

### Embodiment 12

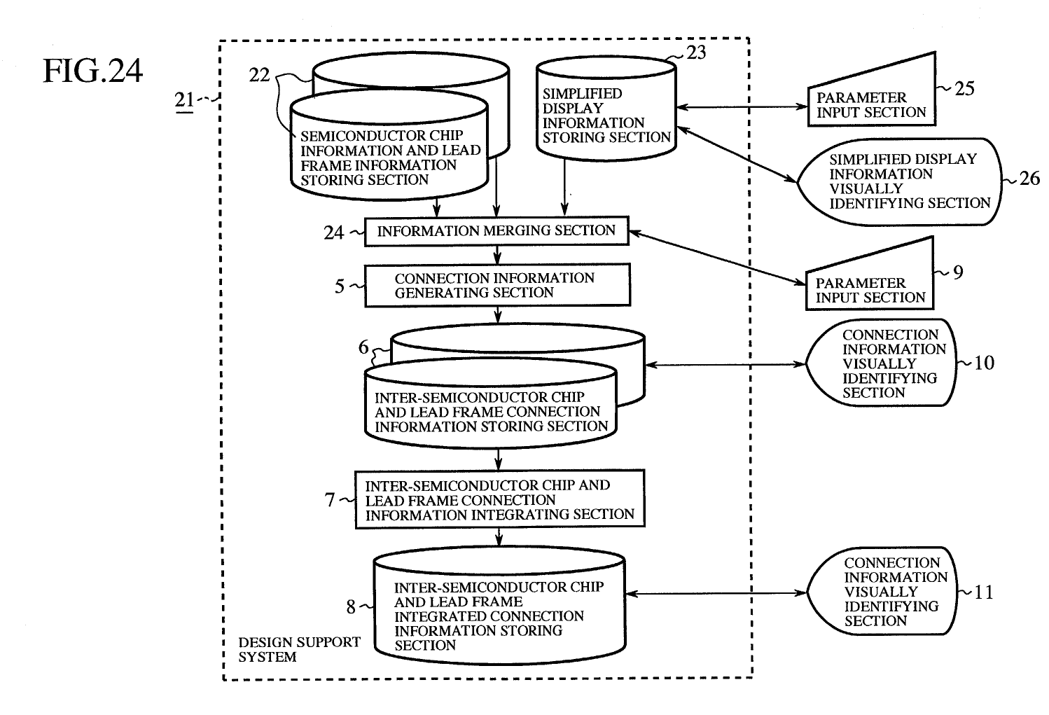

FIG. 24 is a block diagram showing a configuration of a design support system of the embodiment 12 in accordance with the present invention. In FIG. 24, the same reference numerals designate the same or like portions to those of FIG. 1, and the description thereof is omitted here. In FIG. 24, the reference numeral 21 designates a design support system that can generate a connection diagram showing connections between a plurality of semiconductor chips and a lead frame with a function of the simplified display. In the design support system 21, the reference numeral 22 designates a semiconductor chip information and lead frame information storing section reserved on a magnetic recording device or the like to store the semiconductor chip information and lead frame information; 23 designates a simplified display information storing section reserved on the magnetic recording device to store the simplified display information for generating the simplified display diagram; and 24 designates an information merging section that reads the semiconductor chip information, lead frame information and simplified display information from the semiconductor chip information and lead frame information storing section 22 and the simplified display information storing section 23, and generates the semiconductor chip and lead frame merged information so that the semiconductor chip, lead frame and simplified display diagram are displayed in a single drawing by merging their relative coordinates for individual semiconductor chips. The reference numeral 25 designates a parameter input section for inputting or changing the parameters such as the coordinates or sizes of the simplified display information; and 26 designates a simplified display information visually identifying section for generating graphical representation of the simplified display information stored in the simplified display information storing section 23 to enable a user to carry out visual check using the monitor.

FIG. 25 is a simplified display diagram showing a simplified display generated by the design support system of the present embodiment 12. In FIG. 25, the reference numeral 221 designates a die pad passing through the simplified display; 222 designates a first semiconductor chip passing through the simplified display; and 223 designates a second semiconductor chip passing through the simplified display. The die pad 221, first semiconductor chip 222 and second semiconductor chip 223 that are displayed in a simplified fashion correspond to the die pad 112, first semiconductor chip 113 and second semiconductor chip 116 as shown in FIG. 2, respectively.

Next, the operation of the present embodiment 12 will be described.

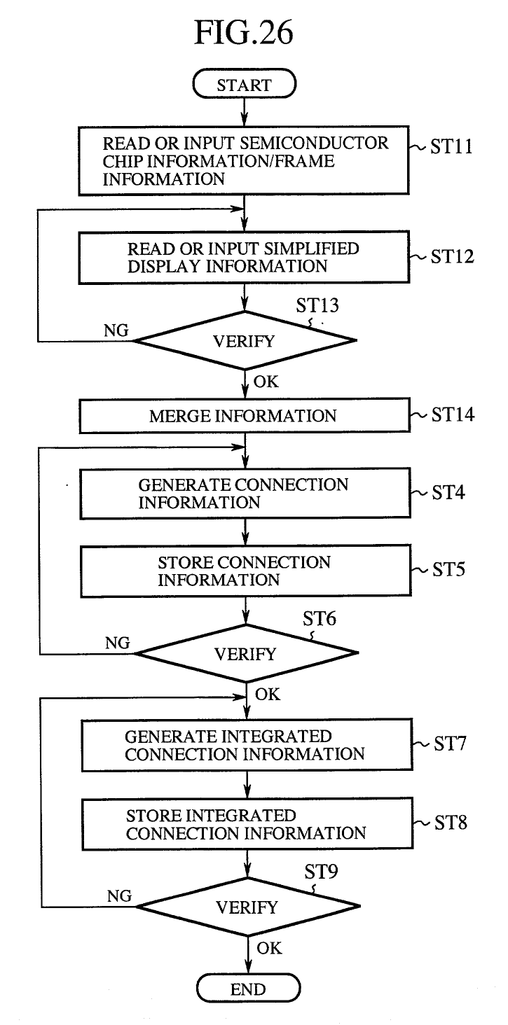

FIG. 26 is a flowchart illustrating the operation of the design support system of the present embodiment 12.

First, at step ST11, the information merging section 24 reads the semiconductor chip information and lead frame information from the semiconductor chip information and lead frame information storing section 22, or inputs from the parameter input section 9. Subsequently, at step ST12, it reads the simplified display information from the simplified display information storing section 23, or inputs from the parameter input section 25. Subsequently, at step ST13, a user verifies the simplified display diagram on the simplified display information visually identifying section 26. When the verification result includes no problem, the processing proceeds to step ST14, whereas if it includes some problem the processing returns to step ST12.

Subsequently, at step ST14, the information merging section 24 generates the semiconductor chip and lead frame merged information from the semiconductor chip information, lead frame information and simplified display information so that they can be represented in a single drawing by combining the relative coordinate systems of the semiconductor chip information, lead frame information and simplified display information of respective semiconductor chips. Since the operation of the subsequent steps are the same as the steps ST4-ST9 as illustrated in FIG. 3, the description thereof is omitted here.

As described above, the present embodiment 12 comprises the simplified display information storing section 23, which makes it unnecessary to create the simplified display diagram from the integrated connection information between the semiconductor chips and the lead frame, and which enables the user to select the semiconductor chip about which the integrated connection information between the semiconductor chips and the lead frame is generated from the simplified display diagram that is produced from the simplified display information stored in the simplified display information storing section 23. As a result, the present embodiment 12 offers an advantage of being able to implement the easy verification of the connections at high efficiency.

Although the present embodiment 12 is described taking an example of the MCP comprising only one lead frame, this is not essential. For example, when a plurality of lead frames are used, one of them can be selected to be displayed.

### Embodiment 13

Since the design support system of the embodiment 13 in accordance with the present invention has the same basic configuration as that of the foregoing embodiment 1 as shown in FIG. 1, the description thereof is omitted here. However, the design support system of the present embodiment 13 differs from that of FIG. 1 in that it comprises an inter-semiconductor chip and lead frame connection information integrating section which differs from its counterpart 7 in FIG. 1 in that it has a verification function of counting the number of connecting wires of the individual semiconductor chips from the integrated connection information between the semiconductor chips and the lead frame.

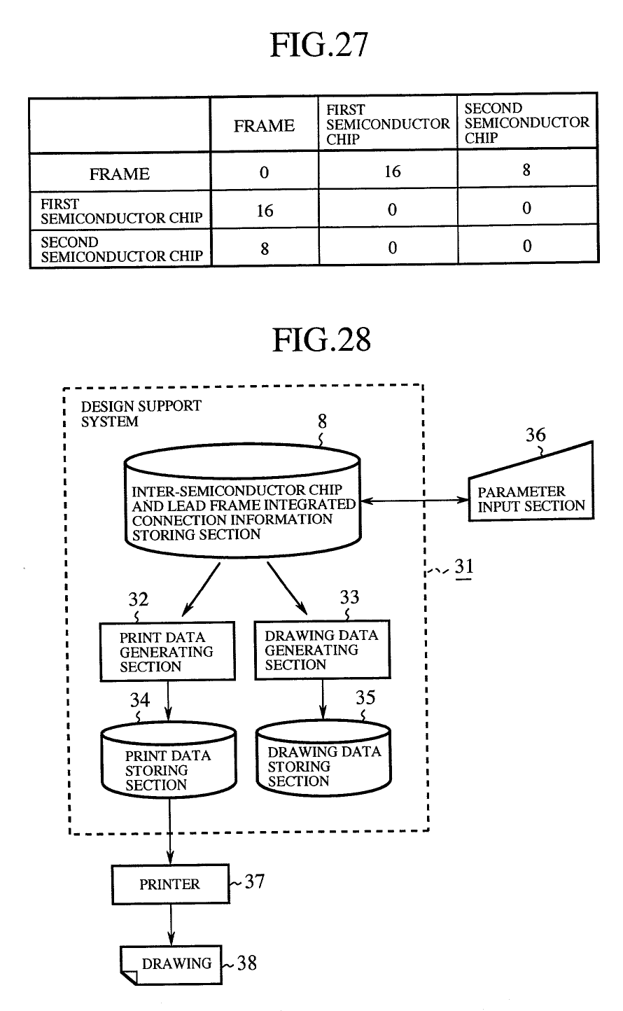

FIG. 27 is a table for verifying the number of connections, which is obtained by counting the number of the connecting wires by the design support system of the present embodiment 13. Here, the table for checking the number of connections as shown in FIG. 27 is produced from the integrated connection information between the semiconductor chips and the lead frame that is generated by the design support system of the embodiment 1 as shown in FIG. 1.

Next, the operation of the present embodiment 13 will be described.

Since the basic operation of the design support system of the present embodiment 13 is the same as that of the foregoing embodiment 1 as shown in FIG. 3, the description thereof is omitted here. However, the design support system of the present embodiment 13 differs in that its connection information visually identifying section 11 makes it possible at step ST9 to verify the table for checking the number of connections as to the integrated connection information between the semiconductor chips and the lead frame. Thus, the present embodiment 13 makes it possible for the user to verify the connections easily and quickly even when the integrated connection information between the semiconductor chips and the lead frame is not represented graphically.

As described above, the present embodiment 13 is configured such that the inter-semiconductor chip and lead frame connection information integrating section 7 has the verification function of counting the number of connection wires of the individual semiconductor chips from the integrated connection information between the semiconductor chips and the lead frame, and generates the integrated connection information between the semiconductor chips and the lead frame from the individual items of the connection information between the semiconductor chips and lead frame that are generated for the respective semiconductor chips. Thus, the connection information visually identifying section makes it possible for the user to verify the table for checking the number of connections. As a result, the present embodiment 13 offers an advantage of making it possible to verify the entire connections easily and quickly, even when the integrated connection information between the semiconductor chips and the lead frame is not represented graphically.

Although the present embodiment 13 is described taking an example of verifying the connection state in the form of a table, it is not limited to such a scheme.

### Embodiment 14

FIG. 28 is a block diagram showing a configuration of a design support system of the embodiment 14 in accordance with the present invention. In FIG. 28, the reference numeral 8 designates an inter-semiconductor chip and lead frame integrated connection information storing section, which is equivalent to its counterpart 8 as shown in FIG. 1. The reference numeral 31 designates a design support system capable of graphically representing and printing the integrated connection information between a plurality of semiconductor chips and a lead frame. In the design support system 31, the reference numeral 32 designates a print data generating section for generating print data from specified integrated connection information between the semiconductor chips and the lead frame; 33 designates a drawing data generating section for generating drawing data from the specified integrated connection information between the semiconductor chips and the lead frame; 34 designates a print data storing section for storing the print data generated by the print data generating section 32; and 35 designates a drawing data storing section for storing the drawing data generated by the drawing data generating section 33.

In addition, the reference numeral 36 designates a parameter input section for specifying the type of the data and the integrated connection information between the semiconductor chips and the lead frame to be generated for the inter-semiconductor chip and lead frame integrated connection information storing section 8; 37 designates a printer for printing the print data stored in the print data storing section 34; and 38 designates a drawing printed by the printer 37.

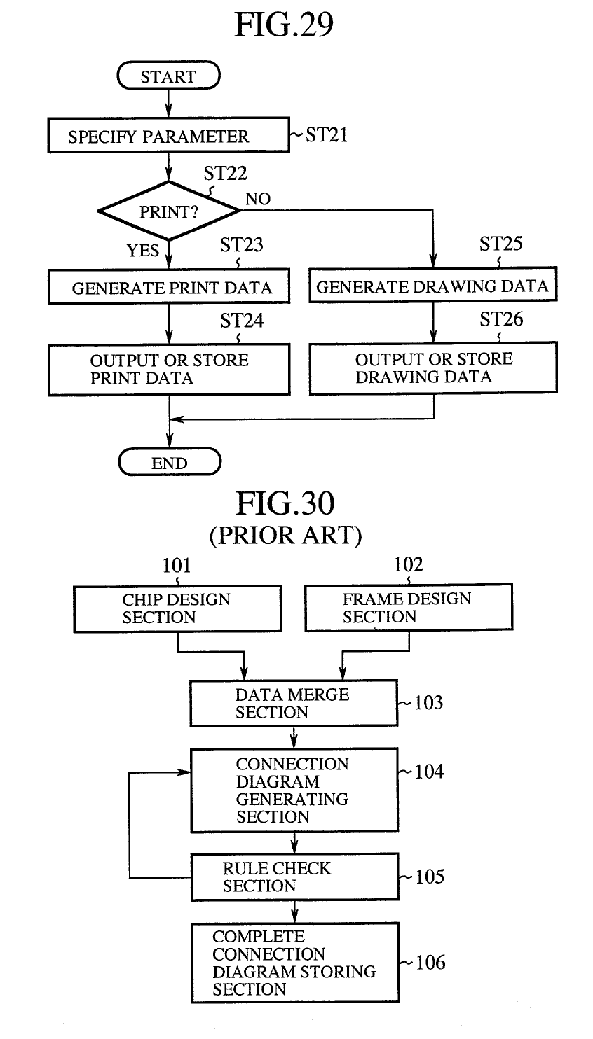

Next, the operation of the present embodiment 14 will be described with reference to a flowchart of FIG. 29 illustrating the operation of the design support system of the present embodiment 14.

First, at step ST21, the parameter input section 36 specifies the type of the data and the integrated connection information between the semiconductor chips and the lead frame for the inter-semiconductor chip and lead frame integrated connection information storing section 8. Subsequently, at step ST22, when the type of the data to be generated which is input from the parameter input section 36 is the print data, the processing proceeds to step ST23, whereas when it is the drawing data, the processing proceeds to step ST25.

Subsequently, at step ST23, the print data generating section 32 generates the print data from the integrated connection information between the semiconductor chips and the lead frame specified by the parameter input section 36. Subsequently, at step ST24, the print data produced by the print data generating section 32 is stored in a recording medium, or output without being stored.

On the other hand, at step ST25, the drawing data generating section 33 generates the drawing data from the integrated connection information between the semiconductor chips and the lead frame, which is specified by the parameter input section 36. Subsequently, at step ST26, the drawing data produced by the drawing data generating section 33 is stored in the recording medium, or output without being stored.

To achieve the printing, the printer 37 prints the drawing 38 according to the print data generated by he print data generating section 32.

As described above, since the present embodiment 14 generates the print data or drawing data, and outputs or stores the data, it offers an advantage of being able to use an external device such as a printer.

What is claimed is:

1. A design support system comprising:
an information merging section for capturing semiconductor chip information and lead frame information, and for generating semiconductor chip and lead frame merged information for individual semiconductor chips;
a connection information generating section for generating connection information between the semiconductor chips and lead frame for the individual semiconductor chips from the semiconductor chip and lead frame merged information generated by said information merging section; and
an inter-semiconductor chip and lead frame connection information integrating section for generating integrated connection information between the semiconductor chips and the lead frame from the connection information between the semiconductor chips and the lead frame generated by said connection information generating section, the integrated connection information enabling the entire connection information between the semiconductor chips and lead frame to be displayed on a single drawing.

2. The design support system according to claim 1, further comprising a recording section for recording at least one of the semiconductor chip information, lead frame information, the connection information between the semiconductor chips and lead frame and the integrated connection information between the semiconductor chips and the lead frame.

3. The design support system according to claim 1, wherein said inter-semiconductor chip and lead frame connection information integrating section has a display type selection function allowing to select colors and shades of gray when producing a drawing.

4. The design support system according to claim 1, wherein said inter-semiconductor chip and lead frame connection information integrating section has a semiconductor chip selection function allowing to select an arbitrary semiconductor chip when producing a drawing.

5. The design support system according to claim 1, wherein said inter-semiconductor chip and lead frame connection information integrating section has a semiconductor chip group layer selection function allowing to select an arbitrary semiconductor chip group consisting of a plurality of semiconductor chips when producing a drawing.

6. The design support system according to claim 1, wherein said inter-semiconductor chip and lead frame connection information integrating section has a forward/reverse rotation selection function allowing to select forward/reverse rotation of the individual semiconductor chips when producing a drawing.

7. The design support system according to claim 1, wherein said inter-semiconductor chip and lead frame connection information integrating section has a component selection function allowing to select an arbitrary component when producing a drawing.

8. The design support system according to claim 1, wherein said inter-semiconductor chip and lead frame connection information integrating section has a display resealing function allowing to changing a scaling factor of any specified region when producing a drawing.

9. The design support system according to claim 1, wherein said inter-semiconductor chip and lead frame connection information integrating section has a 3-D display function allowing to carry out 3-D display of any specified region when producing a drawing.

10. The design support system according to claim 8, wherein said inter-semiconductor chip and lead frame connection information integrating section has a rotating function allowing to rotate, by any specified angle, the integrated connection information between the semiconductor chips and the lead frame, which is displayed by using at least one of a display resealing function and a 3-D display function.

11. The design support system according to claim 9, wherein said inter-semiconductor chip and lead frame connection information integrating section has a rotating function allowing to rotate, by any specified angle, the integrated connection information between the semiconductor chips and the lead frame, which is displayed by using at least one of a display resealing function and a 3-D display function.

12. The design support system according to claim 1, wherein said inter-semiconductor chip and lead frame connection information integrating section has a simplified display function allowing to carry out simplified display of the integrated connection information between the semiconductor chips and the lead frame.

13. The design support system according to claim 1, further comprising a recording section for recording simplified display information, wherein said information merging section captures the semiconductor chip information, the lead frame information and the simplified display information, and generates semiconductor chip and lead frame merged information for individual semiconductor chips.

14. The design support system according to claim 1, wherein said inter-semiconductor chip and lead frame connection information integrating section has a connection wire number verification function of counting a number of connection wires that are connected to each semiconductor chip.

15. The design support system according to claim 1, further comprising a print data generating section for generating print data from the integrated connection information between the semiconductor chips and the lead frame; and a drawing data generating section for generating drawing data from the integrated connection information between the semiconductor chips and the lead frame.

16. A design support method comprising:
an information merging step of capturing semiconductor chip information and lead frame information, and generating semiconductor chip and lead frame merged information for individual semiconductor chips;
a connection information generating step of generating connection information between the semiconductor chips and lead frame for the individual semiconductor chips from the semiconductor chip and lead frame merged information; and
an inter-semiconductor chip and lead frame connection information integrating step of generating integrated connection information between the semiconductor chips and the lead frame from the connection information between the semiconductor chips and the lead frame, the integrated connection information making it possible to display the entire connection information between the semiconductor chips and lead frame in a single drawing.

17. The design support method according to claim 16, wherein the information merging step captures the semiconductor chip information, the lead frame information and simplified display information, and generates the semiconductor chip and lead frame merged information for individual semiconductor chips.

18. The design support method according to claim 16, further comprising a print data generating step of generating print data from the integrated connection information between the semiconductor chips and the lead frame; and a drawing data generating step of generating drawing data from the integrated connection information between the semiconductor chips and the lead frame.
